(19) United States
(12) Patent Application Publication
(10) Pub. No.: US 2004/0111394 A1
(43) Pub. Date: Jun. 10, 2004

(54) Hidden fields for containing debug information

(75) Inventors: Douglas R. Fish, Rochester, MN (US); Cale T. Rath, Byron, MN (US); David A. Wall, Rochester, MN (US)

Correspondence Address: William J. McGinnis, Jr., IBM Corporation, Dept. 917, 3605 Highway 52 North, Rochester, MN, 55901-7829, US

(73) Assignee: International Business Machines Corporation, Armonk, NY (US)

(21) Appl. No.: 10/313,270

(22) Filed: Dec. 6, 2002

(51) Int. Cl. G06F 7/00

(52) U.S. Cl. 707/3

(57) ABSTRACT

A method, apparatus article of manufacture for writing debug data into hidden fields or an electronic document. In some embodiments, debug data is written into hidden fields of an HTML or XML document, which may include visible data, including the results requested by a user. In contrast, the debug data contained in the hidden fields is kept hidden even after rendering the visible portions of the electronic document until, for example, the user takes explicit steps specifically directed to viewing the debug data.

### BACKGROUND OF THE INVENTION

1. Field of the Invention

The present invention generally relates to data processing and more particularly to processing error information in web environments.

2. Description of the Related Art

The Internet has become a cultural fixture as a source of both information and entertainment. Many businesses are creating Internet sites as an integral part of their marketing efforts, informing consumers of the products or services offered by the business or providing other information seeking to engender brand loyalty. Businesses are also increasingly discovering the viability of the Internet as a medium for commercial transactions. Many federal, state, and local government agencies are also employing Internet sites for informational purposes, particularly agencies which must interact with virtually all segments of society such as the Internal Revenue Service. Providing informational guides and/or searchable databases of online public records may reduce operating costs.

The term “Internet” generally refers to the collection of networks and gateways that use the TCP/IP suite of protocols. Currently, the most commonly employed method of transferring data over the Internet is to employ the World Wide Web environment, also called simply “the Web”. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by a URL at the client machine. Retrieval of information on the Web is generally accomplished with an HTML-compatible browser.

Web servers provide static content and dynamic content to various users. Static content contain data from files stored at a server. Dynamic content is often present at a web site in an effort to provide customized pages and updated information to various users that may visit the site. Dynamic content is constructed by programs (web applications) executing at the time a request is made.

One problem in maintaining and developing Web based applications is maintaining and tracking debug information. Debugging in a Web based environment is typically implemented by storing debug and error messages in a single log on the server. However, users can create errors unique to their environment (e.g., security violations and browser version errors) that are not reproducible by other users, and it can be time-consuming to search through a single log to determine which errors are associated with a particular user session. Further, both administrators and developers are burdened by an approach using a single log because administrators have to manage the log files and developers are compelled to restrict the amount of information stored in the log in order to mitigate the burden on administrators as well as the time required to search the log.

Therefore, a method and apparatus for handling debug information in a Web environment is needed.

### SUMMARY OF THE INVENTION

The present invention generally provides for a method, apparatus and article of manufacture for writing debug data into hidden fields. By way of illustration, the hidden fields may be contained in a markup language document, such as an HTML document or XML document.

One embodiment of the invention provides a method of processing error information in a Web environment, comprising issuing a request for Web content and receiving, in response to the request, a Web based electronic document comprising (i) visible output and (ii) at least one hidden field containing error information generated in response to an error occurring during processing of the request. The visible output is displayed while keeping the error information hidden. Subsequently, the error information is displayed.

Another embodiment provides a method of processing error information in a Web environment, comprising receiving, from a requesting entity, a request for Web content; executing a Web application to process the request; encountering an error while executing the Web application to process the request; and writing error information to at least one hidden field of a Web based electronic document. The at least one hidden field is configured to be made visible upon an explicit user action after having been received by the requesting entity. Upon subsequently sending the Web based electronic document, the document contains visible content in addition to the at least one hidden field.

Another embodiment provides an electronic document stored on a computer-readable medium, comprising: visible content for display; and a plurality of hidden debug data fields configured to be populated by error-information-writing code invoked in response to an occurrence of an error during execution of a web application, and wherein the plurality of hidden debug data fields are configured to be made visible upon an explicit user action after having been received by a requesting entity.

Yet another embodiment provides a computer readable medium containing instructions which, when executed, perform an operation for processing error information in a Web environment. The operation includes executing a Web application in response to a network request from a requesting entity; and upon encountering an error while executing the Web application, writing error information to at least one hidden field of a Web based electronic document comprising visible content, wherein visible content is configured to be automatically displayed upon receipt by the requesting entity while the error information is kept hidden and wherein the at least one hidden field is configured to be subsequently revealed upon an explicit user action.

Still another embodiment provides a server computer configured for a network connection, comprising: a server configured to accept requests from requesting entities via the network connection; an application configured to process the requests from the requesting entities; an error handler configured to write debug data into hidden fields of an electronic document in response to an error occurring during execution of the web application while servicing a request from a requesting entity, and Wherein the server subsequently transmits the electronic document to the requesting entity in response to the request.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a networked system 100 in which embodiments of the present invention may be implemented.

FIG. 2 is a flowchart illustrating the transmission of hidden debug data from a server computer to a client computer.

FIG. 3 is a browser screen showing an error that occurred during execution of a Web application.

FIG. 4 is the browser screen of FIG. 3 showing selection of a “Source” menu item to reveal hidden debug/error information encoded within the document being displayed.

FIG. 5 is a window containing the hidden debug/error information encoded into the document of FIG. 3, shown in the background.

FIG. 6 is a browser screen showing an error that occurred during execution of a Web application.

### DETAILED DESCRIPTION OF THE PREFERRED EMBODIMENTS

The present invention provides for a method, apparatus and article of manufacture for writing debug data into hidden fields. In some embodiments, debug data is written into hidden fields of an electronic document, which may include visible data, including the results requested by the user. In this context, “visible” means that the data is rendered and displayed to a user (e.g., by a application such as a browser) without requiring a specific user request to view the data. In contrast, the debug data contained in the hidden fields is kept hidden even after rendering the visible portions of the electronic document until, for example, the user takes explicit steps specifically directed to viewing the debug data.

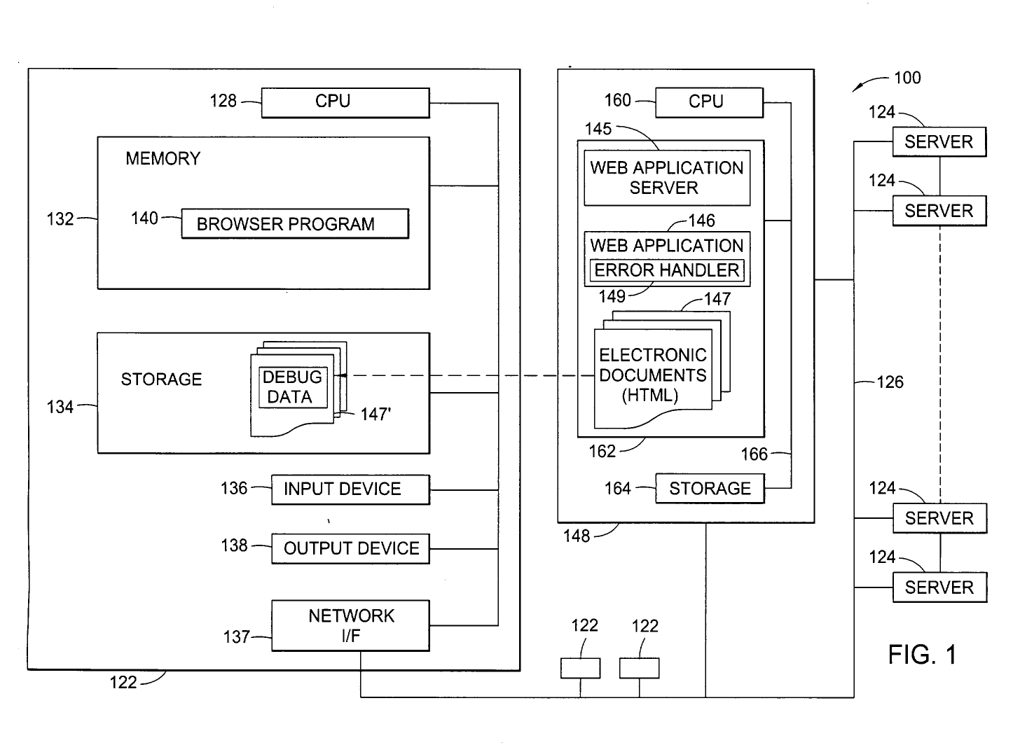

One embodiment of the invention is implemented as a program product for use with a computer system such as, for example, the network system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 depicts a block diagram of a networked system 100 in which embodiments of the present invention may be implemented. In general, the networked system 100 includes a client (e.g., user's) computer 122 (three such client computers 122 are shown) and at least one server 124 (five such servers 124 are shown). The client computer 122 and the server computer 124 are connected via a network 126. In general, the network 126 may be a local area network (LAN) and/or a wide area network (WAN). In a particular embodiment, the network 126 is the Internet.

The client computer 122 includes a Central Processing Unit (CPU) 128 connected via a bus 130 to a memory 132, storage 134, an input device 136, an output device 138, and a network interface device 137. The input device 136 can be any device to give input to the client computer 122. For example, a keyboard, keypad, light pen, touch-screen, track-ball, or speech recognition unit, audio/video player, and the like could be used. The output device 138 can be any device to give output to the user, e.g., any conventional display screen 190 or set of speakers 180 along with their respective interface cards, i.e., video card 195 and sound card 185. Although shown separately from the input device 136, the output device 138 and input device 136 could be combined. For example, a display screen with an integrated touch-screen, a display with an integrated keyboard, or a speech recognition unit combined with a text speech converter could be used.

The network interface device 137 may be any entry/exit device configured to allow network communications between the client computer 122 and the server computers 124 via the network 126. For example, the network interface device 137 may be a network adapter or other network interface card (NIC).

Storage 134 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 132 and storage 134 could be part of one virtual address space spanning multiple primary and secondary storage devices.

The client computer 122 is generally under the control of an operating system 158, which is shown in the memory 132. Illustrative operating systems, which may be used to advantage, include Linux and Microsoft Windows. More generally, any operating system supporting the browser functions disclosed herein may be used.

The memory 132 is preferably a random access memory sufficiently large to hold the necessary programming and data structures of the invention. While the memory 132 is shown as a single entity, it should be understood that the memory 132 may in fact comprise a plurality of modules, and that the memory 132 may exist at multiple levels, from high speed registers and caches to lower speed but larger DRAM chips.

Illustratively, the memory 132 includes an application 140 that, when executed on CPU 128, provides support for exchanging information between the various servers 124 and locating network addresses at one or more of the servers 124. In one embodiment, the application 140 is a browser that includes a web-based Graphical User Interface (GUI), which allows the user to navigate and display web pages located on the Internet. However, more generally the application may be a thin client application configured to transfer data (e.g., HTML, XML, etc.) between the client computer 122 and the servers 124 via, for example, HTTP. By way of example only, the application 140 will be referred to herein as a browser.

Each server computer 124 generally comprises a CPU 160, a memory 162, and a storage device 164, coupled to one another by a bus 166. Memory 162 may be a random access memory sufficiently large to hold the necessary programming and data structures that are located on the server computer 124. The programming and data structures may be accessed and executed by the CPU 160 as needed during operation. As shown, the memory 162 includes a Web application server 145 and a Web application 146. The Web application server 145 is adapted to service requests from the client computer 122 which invoke the Web application 146. In turn, the Web application 146 may perform various functions which include generating, accessing and/or populating electronic documents 147 (e.g., markup language documents such as HTML documents and XML documents) residing on the server computer 124. As used herein, an “electronic document” is machine-readable data, regardless of the medium of storage or transmission. In one embodiment, the documents 147 are Web pages each having an associated network address. Although the documents are shown in FIG. 1 residing on the server computer 124, it should be understood that the documents 147 need not be static, but instead may be generated by the Web application 146. By way of illustration, the Web application server 145 may be an instance of the Tomcat or IBM WebSphere products. Websphere is available from International Business Machines, Inc. Further, the Web application 146 may be configured to access a back end database or perform other functions. By way of illustration, the Web application 146 may be a stock quote retrieval application, an e-commerce application such as eBay, or an e-business application such as IBM Connect, or a Portal environment such as IBM Websphere portal server, which runs in an application environment. However, more generally, it is contemplated that the invention is adaptable to any application server and applications.

From time to time Web application 146 may encounter errors when executing in response to requests from the browser 140. According to one aspect of the invention, the occurrence of such errors results in calling an error information writer (referred to herein as error handler 149) configured to write error information into hidden fields of an electronic document 147. The error information is also referred to herein as debug data which may include a stack trace, environment variables and other information facilitating debugging. The electronic document containing the debug data is then sent to the client computer 122 where it may be viewed or stored, as represented by the stored documents 147′. The debug data may be stored with the corresponding electronic document 147′ or be extracted and stored separately. The debug data may also be sent (e.g., emailed to a system administrator or other entity). Illustratively, the error handler 149 is shown as part of the Web application 146. However, in another embodiment, the error handler 149 is a separate software component.

FIG. 1 is merely one hardware/software configuration for the networked client computer 122 and server computer 124. Embodiments of the present invention can apply to any comparable hardware configuration, regardless of whether the computer systems are complicated, multi-user computing apparatus, single-user workstations, or network appliances that do not have non-volatile storage of their own. Further, it is understood that while reference is made to particular languages, including HTML, XML and JAVA, the invention is not limited to a particular language, standard or version. Accordingly, persons skilled in the art will recognize that the invention is adaptable to other languages and that the invention is also adaptable to future changes in a particular language as well as to other languages presently unknown. Further, the server 145 and application 146 are merely illustrative and other embodiments adapted to support any known and unknown protocols/functions are contemplated.

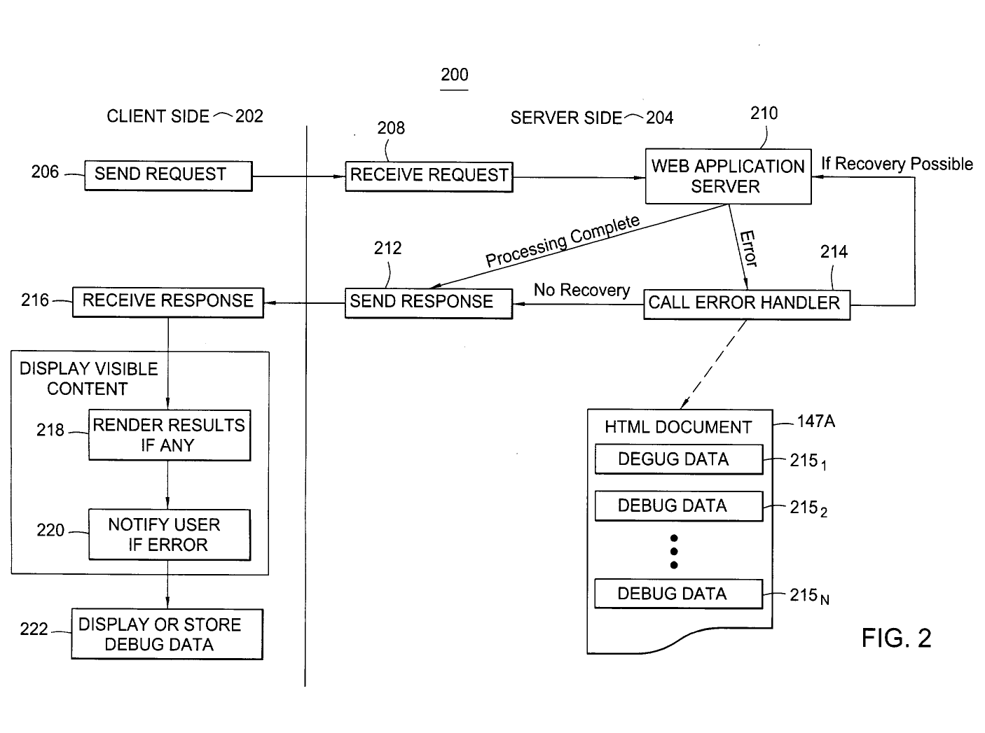

FIG. 2 is a flowchart illustrating the operation 200 of one embodiment of the invention. In general, FIG. 2 shows a client side 202 and a server side 204, where the client side 202 represents operations of the client computer 122 and the server side 204 represents operations of the server computer 124 described with reference to FIG. 1. The operation 200 is described assuming proper initiation of the client and server systems. Accordingly, the browser program 140 has been launched and the Web application 146 is ready to accept requests.

Initially, the browser 140 sends a request to the server computer 224 (step 206). The request is received by the Web application server 145 (step 208) and then provided to the Web application 146. The appropriate code of the Web application 146 then executes to service the request and provide the desired results (step 210).

During execution, the Web application 146 may encounter an error. For example, an exception may be thrown or an unacceptable value may be returned. The software components for detecting such errors (e.g., exception handlers) and generating appropriate error messages in response thereto are well known and do not require further elaboration. If no error occurs, a response is returned to the client computer 122 (step 212). However, if an error occurs, the Web application 146 calls the error handler 149 (step 214). The error handler 149 is configured to write error information (debug data) into hidden fields 220₁, 220₂ . . . 220_{N} (collectively hidden fields 220) of an electronic document 147A, illustratively an HTML document. If a recovery is possible after an error occurs, the Web application 146 continues executing until processing is complete, at which time a response is sent to the client computer 122 (step 212). Of course, during continuing execution following recovery from an error, other errors may occur and be handled according to the invention. If a recovery is not possible, Web application server 145 sends a response containing only the debug data and an error message (i.e., the content originally requested by the user, via the request at step 206, are not returned).

Accordingly, a response sent to the browser 140 by the Web application server 145 may include either the requested content without debug information and an error message, the requested content with debug information and an error message, and debug information and an error message without the requested content. In any case, the browser 140 receives the response (at step 216). The requested results, if any, are then rendered for display to the user (step 218). If the response contains an error message, the message is displayed to the user (step 220). The user may then take steps to view and/or store the hidden debug data (step 222). In one embodiment, the hidden debug data, or selected types of hidden debug data, are automatically stored locally on the client computer 122. However, in order to avoid coding conventional browsers to perform such a task, and in order to avoid the problems associated with prior art (e.g., voluminous information requiring management), the user is preferably given the option of whether and which data to store.

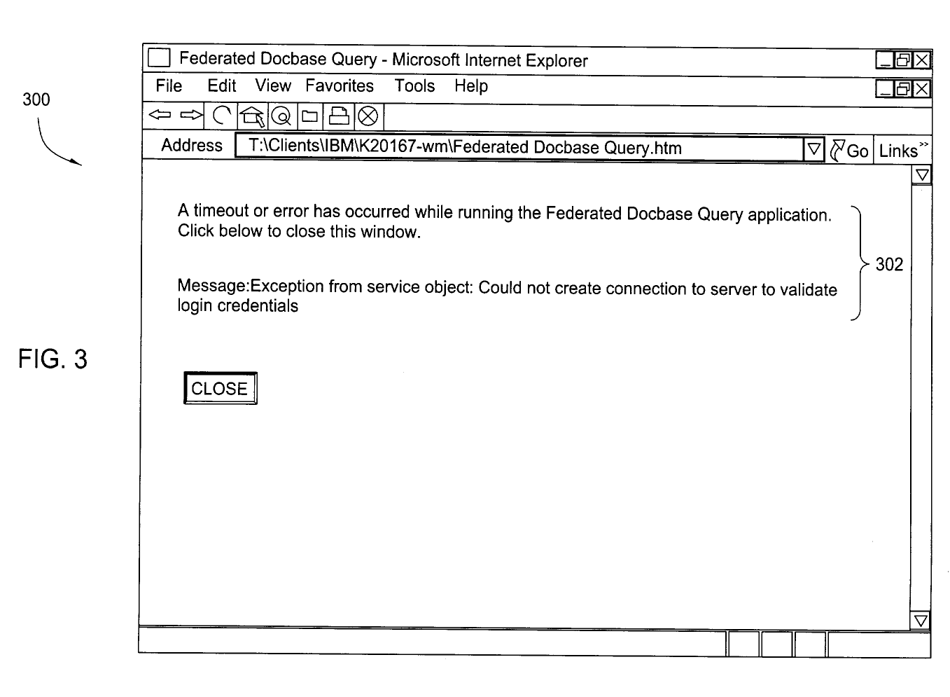

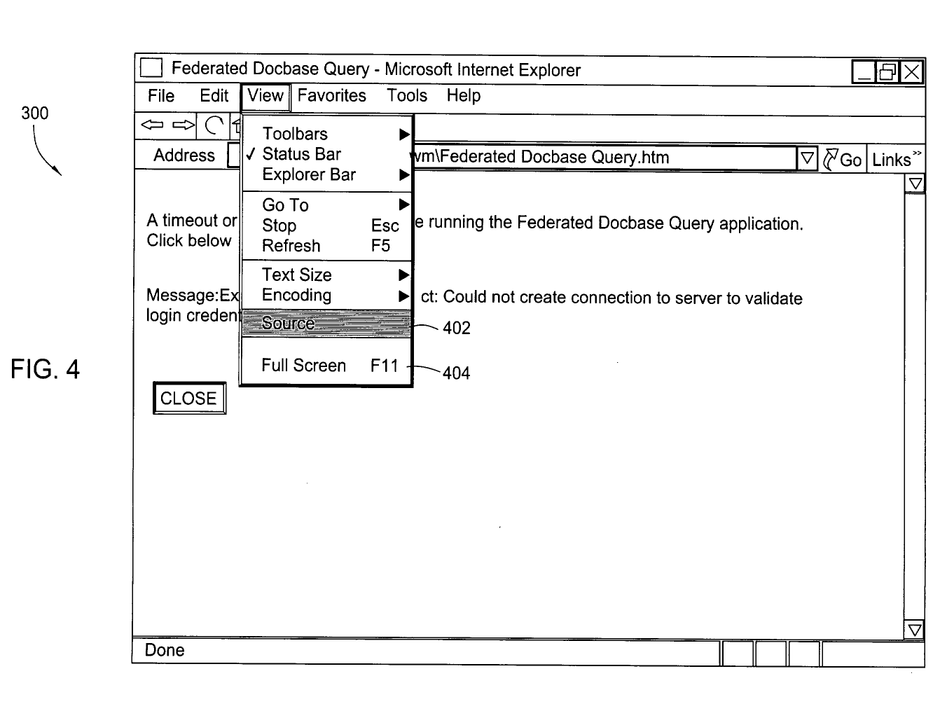

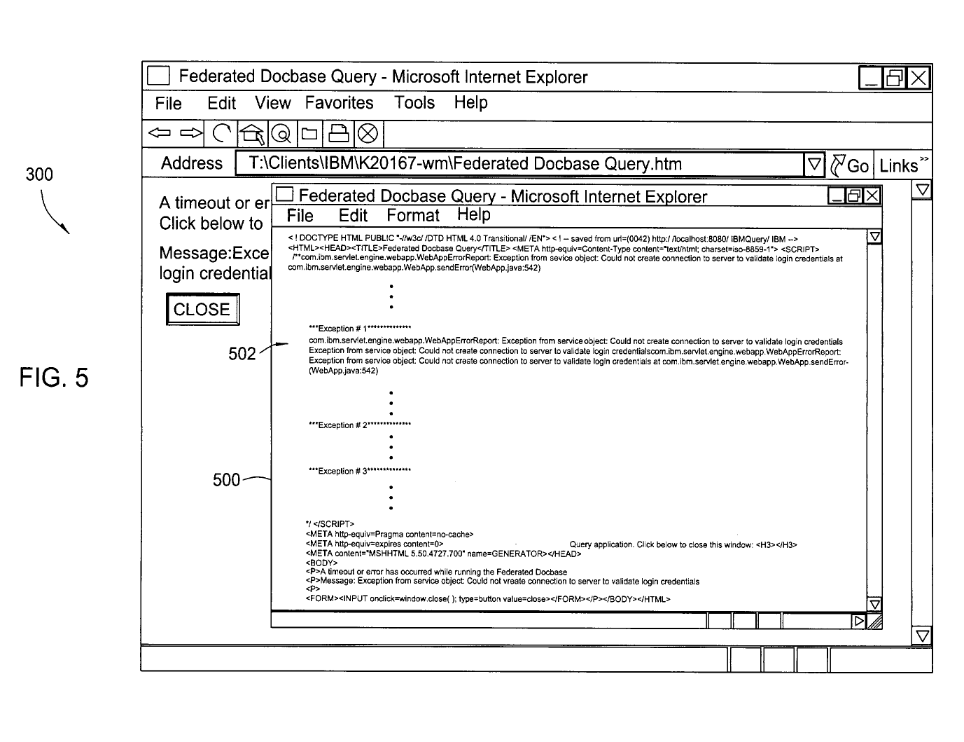

Because the debug data is hidden, the debug data is not viewable from either the returned requested content, or the error message screen (in the case where the content and error message are separate pages). However, the user may view the hidden data by, for example, making appropriate menu selections from the tool bar of the browser 140. One embodiment of such a user operation is illustrated with respect to FIGS. 3-5. Referring first to FIG. 3, a browser screen 300 (illustratively for the Internet Explorer Web browser) displaying an error message 302 is shown. Accordingly, the screen 300 indicates to a user that an error occurred while processing the user's request (specifically, an error occurred while running the Web application 146, referred to in FIG. 3 as the “Federated Docbase Query application”). The user may then select the “Source” menu item 402 from the “View” dropdown menu 404, as shown in FIG. 4. Clicking on the “Source” menu item reveals the hidden debug data 502 in a separate window 500, as shown in FIG. 5.

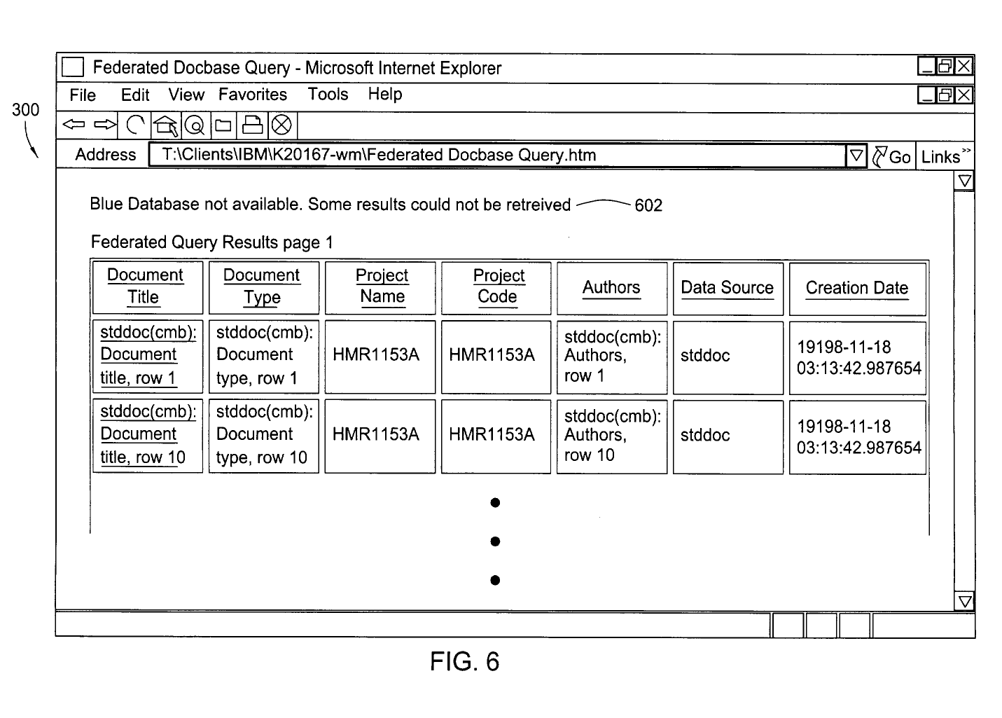

In the example illustrated by FIGS. 3-5, no content was returned to the user in response to the user's request because the Federated Docbase Query application was not able to recover from the error. FIG. 6 illustrates an example in which recovery after an error was possible, and content was returned and displayed to the user via the browser screen 300. A message 602 at the top of the document indicates the occurrence of an error and alerts the user to associated debug data. Again, the associated debug data is not visible but can be accessed in the manner described above with respect to FIGS. 3-5.

The debug data 502 shown in FIG. 5 is shown contained within JavaScript script tags. The following is an illustration of code which may define the error handler 149 configured to encode an exception stack trace inside comments of JavaScript script tags.

Example Java Server Page (JSP) Code Of Error Handler

| | |
|---|---|
| 001 | <% |
| 002 | java.io.Writer writer = response.getWriter( ): |
| 003 | writer.write(“<SCRIPT>/**”); |
| 004 | exception.printStackTrace((java.io.PrintWriter)writer); |
| 005 | writer.write(“**/ </SCRIPT>”); |
| 006 | %> |
| 007 | <P>An error occurred in the application. |
| 008 | Please contact your system administrator. |

In the foregoing example, the code corresponding to one embodiment of the error handler 149 is provided in lines 001-006. Lines 007-008 provide an illustrative error message which is displayed upon the occurrence of an exception stack trace. Illustratively, the error handler 149 is configured to write the debug data into JavaScript script tags. However, persons skilled in the art will recognize that the particular code used to perform the inventive operations need not be of a particular language or structure. For example, the following provides an corresponding example in which the debug data is contained in HTML fields (specifically, comment tags).

Example HTML Code of Error Handler

| | |
|---|---|
| 001 | <% |
| 002 | java.io.Writer writer = response.getWriter( ): |
| 003 | writer.write(“<!—”); |
| 004 | exception.printStackTrace((java.io.PrintWriter) writer); |
| 005 | writer.write(“-->”); |
| 006 | %> |
| 007 | <P>An error occurred in the application. |
| 008 | Please contact your system administrator. |

Accordingly, the foregoing examples are merely for purposes of illustration and not limiting of the invention.

It can be recognized that aspects of encoding debug information into hidden fields of a document displayed to a user provide various advantages over the prior art. In one aspect, advantages are achieved from a user interface perspective because debugging information is not immediately viewable to the end-user, resulting in a more user-friendly error page. In another aspect, the solution is desirable to administrators because debugging information need not be stored persistently on a server, thereby eliminating the need to manage server side log files. In yet another aspect, development is facilitated because debug information is made available without substantially impacting the end-user experience or using excessive disk space for a log. In yet another aspect, overhead time during problem determination is reduced because there is no need to search through a single log file containing debug information for all users sessions.

While the foregoing is directed to embodiments of the present invention, other and further embodiments of the invention may be devised without departing from the basic scope thereof, and the scope thereof is determined by the claims that follow.

What is claimed is:

1. A method of processing error information in a Web environment, comprising:
issuing a request for Web content;
receiving, in response to the request, a Web based electronic document comprising (i) visible output and (ii) at least one hidden field containing error information generated in response to an error occurring during processing of the request;
displaying the visible output while keeping the error information hidden; and then
displaying the error information.

2. The method of claim 1, wherein displaying the error information occurs in response to a user request to view the error information.

3. The method of claim 1, wherein displaying the visible output comprises indicating a presence of the error information.

4. The method of claim 1, wherein the request is issued from and displayed by a Web browser.

5. The method of claim 1, wherein the request is issued from a thin client application.

6. The method of claim 1, wherein the electronic document is a markup language document defined by source markup language and wherein the at least one hidden field is part of the source markup language.

7. The method of claim 1, wherein the hidden fields are one of JavaScript script tags and HTML comment tags.

8. A method of processing error information in a Web environment, comprising:
receiving, from a requesting entity, a request for Web content;
executing a Web application to process the request;
encountering an error while executing the Web application to process the request;
writing error information to at least one hidden field of a Web based electronic document, wherein the at least one hidden field is configured to be made visible upon an explicit user action after having been received by the requesting entity; and
sending the Web based electronic document to the requesting entity, wherein upon sending the Web based electronic document, the document contains visible content in addition to the at least one hidden field.

9. The method of claim 8, wherein the visible content comprises an error message indicating the error.

10. The method of claim 8, wherein the error is specific to the requesting entity.

11. The method of claim 8, wherein visible content comprises the Web content requested by the requesting entity.

12. The method of claim 8, wherein the electronic document is a markup language document defined by source markup language and wherein the at least one hidden field is part of the source markup language.

13. The method of claim 8, wherein the requesting entity is one of a Web browser and a thin client application.

14. An electronic document stored on a computer-readable medium, comprising:
visible content for display; and
a plurality of hidden debug data fields configured to be populated by error-information-writing code invoked in response to an occurrence of an error during execution of a web application, and wherein the plurality of hidden debug data fields are configured to be made visible upon an explicit user action after having been received by a requesting entity.

15. The electronic document of claim 14, wherein the visible content is web content requested by the requesting entity.

16. The electronic document of claim 14, wherein the visible content is an error message corresponding to the error.

17. The electronic document of claim 14, wherein the error is specific to the requesting entity.

18. The electronic document of claim 14, wherein the requesting entity is one of a Web browser and a thin client.

19. The electronic document of claim 14, wherein visible content and the plurality of hidden debug data fields are defined by source markup language.

20. The electronic document of claim 14, wherein the plurality of hidden fields are one of JavaScript script tags and HTML comment tags.

21. A computer readable medium containing instructions which, when executed, perform an operation for processing error information in a Web environment, comprising:
executing a Web application in response to a network request from a requesting entity; and
upon encountering an error while executing the Web application, writing error information to at least one hidden field of a Web based electronic document comprising visible content, wherein visible content is configured to be automatically displayed upon receipt by the requesting entity while the error information is kept hidden and wherein the at least one hidden field is configured to be subsequently revealed upon an explicit user action.

22. The computer readable medium of claim 21, wherein visible content and the at least one hidden debug data field are defined by source markup language which defines the electronic document.

23. The computer readable medium of claim 21, wherein the visible content is web content requested by the requesting entity.

24. The computer readable medium of claim 21, wherein the visible content is an error message corresponding to the error.

25. The computer readable medium of claim 21, wherein the error is specific to the requesting entity.

26. A server computer configured for a network connection, comprising:
a server configured to accept requests from requesting entities via the network connection;
a application configured to process the requests from the requesting entities;
an error handler configured to write debug data into hidden fields of an electronic document in response to an error occurring during execution of the web application while servicing a request from a requesting entity, and wherein the server subsequently transmits the electronic document to the requesting entity in response to the request.

27. The system of claim 26, wherein the electronic document is one of an HTML document and an XML document.

28. The system of claim 26, wherein the requesting entity is one of a browser and a thin client.

29. The system of claim 26, wherein the error is specific to the requesting entity.

30. The system of claim 26, wherein the error handler is part of the Web application.

31. The system of claim 26, further comprising a network connector to support a connection to the Internet.

32. The system of claim 26, wherein the error handler is further configured to write visible data into the electronic document, wherein the visible data is configured to be automatically displayed upon receipt by the requesting entity while the debug data is kept hidden.

33. The system of claim 32, wherein visible content and the hidden fields are defined by common source markup language which defines the electronic document.
